(19) United States
(12) Patent Application Publication
(10) Pub. No.: US 2005/0150837 A1
(43) Pub. Date: Jul. 14, 2005

(54) Denitrogenation of liquid fuels

(76) Inventors: Ralph T. Yang, Ann Arbor, MI (US); Arturo J. Hernandez-Maldonado, Ann Arbor, MI (US)

Correspondence Address: JULIA CHURCH DIERKER;DIERKER & ASSOCIATES, P.C., 3331 W. BIG BEAVER RD. SUITE 109, TROY, MI, 48084-2813, US

(21) Appl. No.: 10/754,335

(22) Filed: Jan. 9, 2004

(51) Int. Cl. C02F 1/28

(52) U.S. Cl. 210/670; 210/690

(57) ABSTRACT

A method for removing organo-nitrogen compounds from liquid fuel includes contacting the liquid fuel with an adsorbent which preferentially adsorbs the organo-nitrogen compounds. The adsorption takes place at a selected temperature and pressure, thereby producing a non-adsorbed component and an organo-nitrogen compound-rich adsorbed component. The adsorbent includes either a metal or a metal cation that is adapted to form π-complexation bonds with the organo-nitrogen compounds, and the preferential adsorption occurs by π-complexation.

### STATEMENT REGARDING FEDERALLY SPONSORED RESEARCH OR DEVELOPMENT

This invention was made in the course of research partially supported by a grant from the National Science Foundation (NSF) (Grant No. CTS-0138190). The U.S. government has certain rights in the invention.

### BACKGROUND OF THE INVENTION

The present invention relates generally to processes for the purification of liquid fuels and, more particularly, to adsorption processes using sorbents selective to remove organo-nitrogen compounds from transportation fuels.

Liquid fuels are extremely complex mixtures and consist predominantly of hydrocarbons, as well as compounds containing nitrogen, oxygen, and sulfur. Most liquid fuels also contain minor amounts of nickel and vanadium. The chemical and physical properties of liquid fuels vary considerably because of the variations in composition.

The ultimate analysis (elemental composition) of liquid fuel tends to vary over relatively narrow limits—carbon: 83.0 to 87.0 percent; hydrogen: 10.0 to 14.0 percent; nitrogen: 0.1 to 1.5 percent; oxygen: 0.1 to 1.5 percent; sulfur: 0.1 to 5.0 percent; metals (nickel plus vanadium): 10 to 500 ppm.

It would be desirable to remove organo-nitrogen compounds from liquid fuels. Denitrogenation is important to many different refinery processes. Further, denitrogenation would help to lower emission of nitrogen oxides from combustion processes. More recently, the oil industry is facing increasing pressure to remove organo-nitrogen compounds from transportation fuels (non-limitative examples of which include gasoline, diesel and jet fuels), due in part to the fact that organo-nitrogen compounds may in some cases be responsible for the low reactivity of refractory sulfur compounds during sulfur removal processes, such as hydrodesulfurization. In addition, it has become increasingly important to process heavy, low-quality stocks and the anticipated syncrudes, both of which are rich in highly refractory nitrogen compounds.

Denitrogenation and desulfurization are accomplished commercially by hydrotreating using catalysts in reactors under high temperatures and pressures. Denitrogenation and desulfurization are coupled and are performed simultaneously in catalytic hydrotreating, which is an integral part of oil refining. Thus, hydrodenitrogenation (HDN) is accomplished by reacting with hydrogen at 20-100 atm pressure and 300-380° C. using CoMo/Al₂O₃ or NiMo/Al₂O₃ as the catalyst.

Two types of organo-nitrogen compounds are found in petroleum and syncrudes: heterocycles and nonheterocycles. The latter consist of anilines and aliphatic amines which are relatively easy to remove by HDN. The heterocycles include compounds containing the six-member pyridine ring, and those containing the five-member pyrrole ring. The derivatives of pyridine and pyrrole include those with one or two benzene rings as well as alkyl-substituted benzene rings. The kinetics of HDN are not well understood; however, some basic facts are known. The reactivities of the organo-nitrogen compounds are significantly lower than that of the corresponding organo-sulfur compounds. For example, the alkyl-substituted carbazoles (i.e., pyrrole sandwiched between two benzene rings, the most abundant nitrogen compounds) appear to react at rates about 1/10 as fast as those of alkyl-dibenzothiophenes of comparable structures. Thus, it is more difficult to remove organo-nitrogen compounds than organo-sulfur compounds because the organo-nitrogen compounds are much less reactive than the organo-sulfur compounds.

### SUMMARY OF THE INVENTION

The present invention addresses and substantially solves the above-mentioned drawbacks by providing a process for removing nitrogen compounds from liquid fuel. The method comprises the step of contacting the liquid fuel with an adsorbent which preferentially adsorbs the nitrogen compounds, at a selected temperature and pressure, thereby producing a non-adsorbed component and a nitrogen compound-rich adsorbed component. The adsorbent may comprise any ion-exchanged zeolite. In an embodiment, the zeolite is selected from the group consisting of zeolite X, zeolite Y, zeolite LSX, MCM-41 zeolites, silicoaluminophosphates (SAPOs), and mixtures thereof. The zeolite has exchangeable cationic sites, and at least some of the sites have metal or metal cations present that are adapted to 7r-complex. Further, the metals/metal cations do not need to be ion-exchanged, but rather may be dispersed (monolayer dispersion, island dispersion, etc.) on a carrier (such as, for example, silica, alumina, etc.) by any suitable method. The preferential adsorption occurs by π-complexation.

### BRIEF DESCRIPTION OF THE DRAWINGS

Objects, features and advantages of the present invention will become apparent by reference to the following detailed description and drawings, in which:

FIG. 1 is a graph of the adsorption bond energies of various molecules on a CuY zeolite;

FIG. 2 is a schematic view of an aniline molecule interacting with a cuprous zeolite cluster;

FIG. 3 is a graph illustrating the GC-CLND chromatogram results of the denitrogenation of commercial diesel fuel containing 83 ppmw nitrogen using CuY as the sorbent (the sampling time is expressed by cumulative effluent volume normalized by the sorbent weight (cm³g⁻¹)); and

FIG. 4 is a graph depicting a nitrogen breakthrough curve with Cu(I)Y adsorbent, with diesel feed at room temperature. Ci is the total nitrogen concentration of the feed (83 ppmw).

### DETAILED DESCRIPTION OF THE PREFERRED EMBODIMENTS

It is a significant challenge to use adsorption to selectively remove organo-nitrogen compounds from transportation fuels, as presently available commercial sorbents cannot selectively adsorb the nitrogen compounds. The present invention has unexpectedly and fortuitously achieved this highly selective adsorption at ambient temperature and pressure (in sharp contrast to the high temperatures and pressures used in HDN). In sharp contrast to the hydrodesulfurization (HDS) of liquid fuels process, the present invention may advantageously remove both organo-nitrogen compounds and sulfur compounds simultaneously, if desired. It is believed that the present invention will lead to major advances in petroleum refining.

The present invention is predicated upon the unexpected and fortuitous discovery that organo-nitrogen compounds are adsorbed slightly more selectively via π-complexation than is benzene. This is quite counter-intuitive, as it would be expected that benzene, having more double bonds (3) and more π electrons than heterocycles including compounds containing six-member pyridine rings and those containing five-member pyrrole rings, would be more selectively adsorbed via π-complexation. An example of a compound having more double bonds being more selectively adsorbed than a compound having fewer double bonds may be found in U.S. Pat. No. 6,215,037, issued to Padin, Munson and Yang entitled, “Method for Selective Adsorption of Dienes.”

Without being bound to any theory, it is believed that this counter-intuitive, slightly higher selectivity for organo-nitrogen derivatives/compounds may be explained by the following theory. The nitrogen atom in, for example, the pyridine and pyrrole rings has more electrons than the carbons. As such, the N atom, with its available electrons and relatively strong attraction, may be aiding in the π-complexation bonding, thus contributing to the higher selectivity of the present sorbents for organo-nitrogen compounds over benzene. How much the nitrogen could contribute to π-complexation bonding, however, is not predictable.

The present inventors have discovered that denitrogenation may be achieved effectively by using a zeolite sorbent that removes the nitrogen molecules by selective adsorption at ambient temperature and pressure. A non-limitative example shows that the sorbent removes nitrogen from a commercial diesel fuel that contains 83 parts per million by weight (ppmw) nitrogen to well below 0.1 ppmw nitrogen at a sorbent capacity of 43 cm³ diesel per gram of sorbent. The sorbent may advantageously be regenerated for re-use, if desired.

A class of highly nitrogen-selective and high-nitrogen-capacity sorbents is discussed hereinbelow. This class of sorbents binds the organo-nitrogen compounds selectively by π-complexation.

In an embodiment of the present invention, the process for removing organo-nitrogen compounds from liquid fuel includes the step of contacting the liquid fuel with an adsorbent that preferentially adsorbs the organo-nitrogen compounds, at a selected temperature and pressure, thereby producing a non-adsorbed component and an organo-nitrogen compound-rich adsorbed component.

The adsorbent may include any ion-exchanged zeolite, but in a preferred embodiment, the zeolite is selected from the group consisting of zeolite X, zeolite Y, zeolite LSX, MCM-41 zeolites, silicoaluminophosphates (SAPOs), and mixtures thereof. The zeolite has exchangeable cationic sites. In an embodiment, at least some of the sites have a metal or a metal cation present. In a further embodiment, a majority of the sites have a metal or a metal cation present. In yet a further embodiment, up to about 96 univalent sites may be exchanged with a metal or metal cation per zeolite unit cell. A non-limitative example of such a zeolite includes the LSX zeolite, with the ratio of Si/Al equaling 1.0. It is believed that the preferential adsorption occurs by π-complexation.

Although the process of the present invention has specifically tested Cu—Y, it is to be understood that Type X zeolites may in some cases be as good as, or better zeolites than Y zeolites, since more cations are available in X zeolites. Further, it is to be understood that other zeolites are contemplated as being within the scope of the present invention. Still further, it is to be understood that any metal and/or metal cation that will form π-complexation bonds with organo-nitrogen compounds may be used. Various metals and/or their cations (including, but not limited to d-block transition metals) may be used in place of the copper, as it is believed that these metals/metal cations will form π-complexation bonds with organo-nitrogen compounds. In particular, it is believed that Mn²⁺, Fe²⁺, Co²⁺, Cd²⁺, Zn²⁺, Ga³⁺, Ni²⁺, Ag⁺ and Pd⁰ would be as effective as Cu⁺.

Further, the metals/metal cations do not need to be ion-exchanged, but rather may be dispersed (monolayer dispersion, island dispersion, etc.) on a carrier (such as, for example, silica, alumina, etc.) by any suitable method.

Table 1 lists some of these metal and metal cations and their corresponding orbital occupancies. These cations may have empty 4s orbitals while having high occupancies in the 3d orbitals, thus may form π-complexation bonds with organo-nitrogen compounds.

TABLE 1
Cations for π-Complexatio n with Organo-nitrogen Compounds

| | | Cation for π- | |
|---|---|---|---|
| Element | Electronic Configuration | Complexation | Cation Electronic Configuration |
| Manganese | 1s²2s²2p⁶3s²3p⁶3d⁵4s² | Mn²⁺ | 1s²2s²2p⁶3s²3p⁶3d⁵4s⁰ |
| Iron | 1s²2s²2p⁶3s²3p⁶3d⁶4s² | Fe²⁺ | 1s²2s²2p⁶3s²3p⁶3d⁶4s⁰ |
| Cobalt | 1s²2s²2p⁶3s²3p⁶3d⁷4s² | Co²⁺ | 1s²2s²2p⁶3s²3p⁶3d⁷4s⁰ |
| Nickel | 1s²2s²2p⁶3s²3p⁶3d⁸4s² | Ni²⁺ | 1s²2s²2p⁶3s²3p⁶3d⁸4s⁰ |
| Copper | 1s²2s²2p⁶3s²3p⁶3d¹⁰4s¹ | Cu⁺ | 1s²2s²2p⁶3s²3p⁶3d¹⁰4s⁰ |
| Zinc | 1s²2s²2p⁶3s²3p⁶3d¹⁰4s² | Zn²⁺ | 1s²2s²2p⁶3s²3p⁶3d¹⁰4s⁰ |
| Gallium | 1s²2s²2p⁶3s²3p⁶3d¹⁰4s²4p¹ | Ga³⁺ | 1s²2s²2p⁶3s²3p⁶3d¹⁰4s⁰ |
| Palladium | 1s²2s²2p⁶3s²3p⁶3d¹⁰4s²4p⁶4d¹⁰4f⁰5s⁰ | Pd⁰ | 1s²2s²2p⁶3s²3p⁶3d¹⁰4s²4p⁶4d¹⁰4f⁰5s⁰ |
| Silver | 1s²2s²2p⁶3s²3p⁶3d¹⁰4s²4p⁶4d¹⁰4f⁰5s¹ | Ag⁺ | 1s²2s²2p⁶3s²3p⁶3d¹⁰4s²4p⁶4d¹⁰4f⁰5s⁰ |
| Cadmium | 1s²2s²2p⁶3s²3p⁶3d¹⁰4s²4p⁶4d¹⁰4f⁰5s² | Cd²⁺ | 1s²2s²2p⁶3s²3p⁶3d¹⁰4s²4p⁶4d¹⁰4f⁰5s⁰ |

In a further embodiment, the method includes the step of contacting the liquid fuel with an adsorbent which preferentially adsorbs the organo-nitrogen compounds, at a selected temperature and pressure, thereby producing a non-adsorbed component and an organo-nitrogen compound-rich adsorbed component. The adsorbent may include a carrier having a surface area with a metal compound dispersed on at least some of the surface area. The metal compound includes a metal and/or metal cation adapted to form π-complexation bonds with the organo-nitrogen compounds. The metal compound releasably retains the organo-nitrogen compounds. The carrier has a plurality of pores having a pore size greater than the effective molecular diameter of the organo-nitrogen compounds. The method may further include the step of changing at least one of the pressure and temperature to thereby release the organo-nitrogen compound-rich component from the adsorbent.

The present inventive method may advantageously be run at ambient temperature and pressure, which is highly desirable for a variety of reasons. It is much less energy consuming to run processes at ambient temperature and pressure.

A brief description of some non-limitative examples of adsorbents which may successfully be used in the present invention follows. Detailed descriptions may be found in U.S. Pat. No.6,423,881, and in U.S. Pat. No. 6,215,037, each of which patents is incorporated herein by reference in its entirety.

The adsorbent may comprise a carrier having a surface area, the carrier having dispersed thereon a monolayer of a metal compound, a non-limitative example of which is a silver compound. The metal compound releasably retains the organo-nitrogen compounds; and the carrier comprises a plurality of pores having a pore size greater than the effective molecular diameter of the organo-nitrogen compounds.

It is to be understood that any suitable carrier may be used. In a preferred embodiment, the carrier has a BET surface area greater than about 50 square meters per gram and up to about 2,000 square meters per gram, and comprises a plurality of pores having a pore size greater than about 3 angstroms and up to about 10 microns. In a more preferred embodiment, the carrier is a high surface area support selected from the group consisting of refractory inorganic oxide, molecular sieve, activated carbon, and mixtures thereof. Still more preferred, the carrier is a refractory inorganic oxide selected from the group consisting of pillared clay, alumina and silica.

It is also to be understood that any suitable metal compound may be used. However, in a preferred embodiment, the metal compound is a silver (I) and/or copper (I) halide. In a more preferred embodiment, the metal compound is a silver and/or copper salt, and the salt is selected from the group consisting of acetate, benzoate, bromate, chlorate, perchlorate, chlorite, citrate, fluoride, nitrate, nitrite, sulfate, and mixtures thereof.

In one exemplary embodiment of this embodiment of the present invention, the silver compound is silver nitrate (AgNO₃) and the carrier is silica (SiO₂).

The method of the present invention may further comprise the step of changing at least one of the pressure and temperature to thereby release the organo-nitrogen compounds-rich component from the adsorbent. It is to be understood that the pressures and temperatures used may be within a suitable range. However, in the preferred embodiment, the selected pressure of preferential adsorption is a first pressure, and the pressure of release is a second pressure less than the first pressure. In a more preferred embodiment, the first pressure is in a range of about 1 atmosphere to about 35 atmospheres, and the second pressure is in a range of about 0.01 atm to about 5 atm.

In the preferred embodiment, the selected temperature of preferential adsorption is a first temperature, and the temperature of release is a second temperature greater than the first temperature. In a more preferred embodiment, the first temperature is in a range of about 0° C. to about 50° C., and the second temperature is in a range of about 70° C. to about 200° C.

Without being bound to any theory, it is believed that the retaining of the organo-nitrogen compounds is accomplished by formation of π-complexation bonds between the metal compound and the organo-nitrogen compounds.

The π-complexation generally pertains to the main group (or d-block) transition metals, that is, from Sc to Cu, Y to Ag, and La to Au in the periodic table. These metals or their ions (see Table 1) can form the normal σ bond to carbon and, in addition, the unique characteristics of the d orbitals in these metals or ions can form bonds with the unsaturated hydrocarbons (olefins) in a nonclassic manner. This type of bonding is broadly referred to as π-complexation, and has been considered for gaseous hydrocarbon separation and purification using cumbersome liquid solutions.

Without being bound to any theory, it is believed that the higher sorbent capacity of embodiments of the present invention may be due in part to a sorbent pretreatment method of an embodiment of the present invention wherein the sorbent is activated at a temperature ranging between about 250° C. and about 600° C., and is then cooled. In an embodiment, the activation may be carried out for an amount of time ranging between about zero hours and about 20 or more hours. In an alternate embodiment, the activation may be carried out for an amount of time ranging between about 5 hours and about 15 hours. In a further embodiment, the activation may be carried out for an amount of time ranging between about 6 hours and about 12 hours. In an embodiment, the pretreatment process may take place in an inert, air, dry air, and/or reducing atmosphere, depending on the metal or metal cation used. Non-limitative examples thereof include the following: when the metal cation is Ni²⁺, pretreating (activating and/or cooling) may take place in an inert atmosphere, in air, and/or in a dry air atmosphere. When the metal cation is Cu⁺, activation may take place in an inert atmosphere (such as helium) and/or in a reducing atmosphere, and cooling may take place in an inert atmosphere (such as helium). Some non-limitative examples of the reducing atmosphere include reducing gases, such as, for example, hydrogen and/or carbon monoxide, and/or any other suitable reducing gas.

It is further contemplated that the addition of a guard bed may, in some instances, aid somewhat in the denitrogenation of fuels. It is contemplated that all suitable commercial sorbents may be used as a guard bed. In one non-limitative embodiment(s) discussed herein, the present inventors included a guard bed as about 15% of the bed at the inlet thereto; while the main bed that was doing the purification work remained an ion-exchanged zeolite (suitable examples of which are discussed herein). The guard bed may include at least one of activated carbon, activated alumina, silica gel, zeolites, clays, pillared clays, diatomaceous earth, porous sorbents, and mixtures thereof.

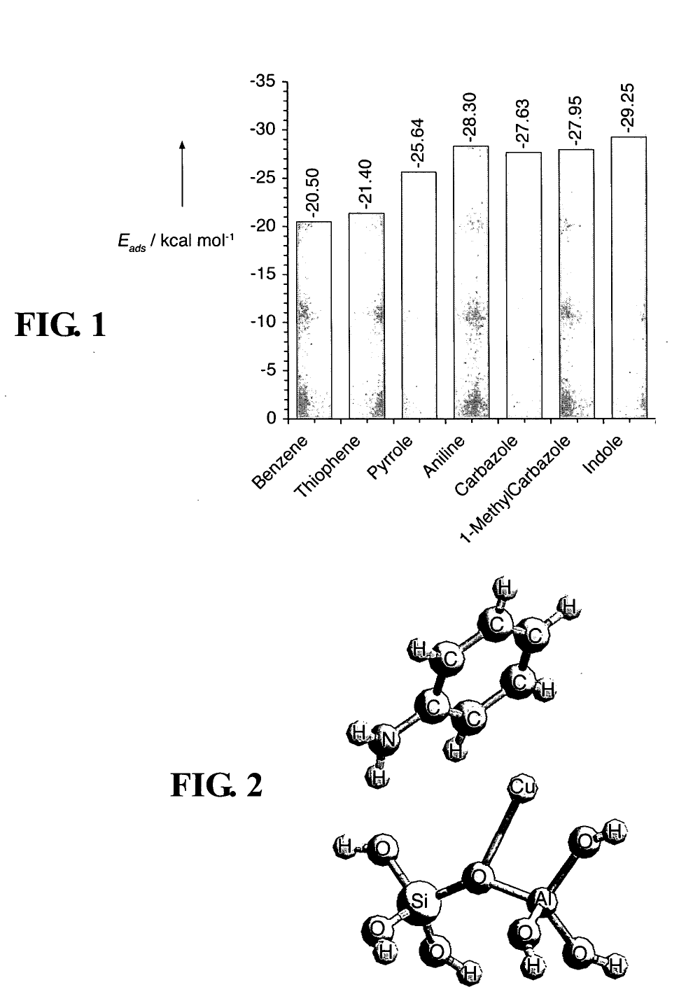

As previously described, the sorbent for denitrogenation may be a zeolite containing metals or metal cations and may be prepared by ion exchange of zeolites using known ion exchange procedures. A non-limitative example includes, but is not limited to a Cu(I)Y zeolite. This candidate was identified in a screening study that used molecular orbital (MO) theory to search for sorbents that would bond the organo-nitrogen molecules more strongly than benzene. Here benzene was used as a model compound for aromatics in transportation fuel that would compete for adsorption sites (by π-complexation) against the nitrogen compounds. The calculations were performed at the Hartree-Fock (HF) and density functional theory (DFT) level using effective core potentials (ECPs). The restricted Hartree-Fock (RHF) theory at the LanL2DZ level basis set was used to determine the geometries and the adsorption bonding energies. Moreover, natural bond orbital (NBO) analysis at the B3LYP/LanL2DZ level was used for studying the electron density distribution of the adsorption system. A cluster model was used to represent the zeolite framework structure to which Cu⁺ cations were bonded. The results on the adsorption bond energies are shown in FIG. 1.

Thiophene, the basic molecule for organo-sulfur compounds in transportation fuels, was also included for comparison. These results indicate that the Cu⁺ zeolite could advantageously adsorb organo-nitrogen compounds preferentially over benzene. Thiophene is also preferentially adsorbed by CuY, but the adsorption of the organo-nitrogen compounds is significantly stronger. The natural bond orbital analysis showed that the bonding followed the classical picture of π-complexation, with some donation of electron charges from the π-orbital of the pyrrole ring to the vacant s orbital of metals known as σ donation and, simultaneously, back donation of electron charges from the d orbitals of metals to π* orbital (i.e., anti-bonding π orbital) of pyrrole, or π back-donation. Since many of the d-block metals and their cations are capable of π-complexation, zeolites with other d-block cations are expected to preferentially adsorb the organo-nitrogen compounds as well.

It is contemplated that for molecules containing amine or other functional groups, the adsorption energy is higher because of the electron-donating effect of the methyl group to the aromatic ring (FIG. 1).

A schematic representation of an aniline molecule interacting with a cuprous zeolite cluster is shown in FIG. 2. Without being bound to any theory, it is believed that due to π-complexation, organo-nitrogen molecules adsorb on CuY in a flatwise, face-down manner, and hence are devoid of steric hindrance (which hindrance inhibits their reaction in HDN).

To further illustrate the present invention, the following example is given. It is to be understood that the example is provided for illustrative purposes and is not to be construed as limiting the scope of the present invention.

### EXAMPLE

Adsorption experiments were completed for denitrogenation of a commercial diesel fuel in a fixed-bed adsorber that contained particles of CuY zeolite, at ambient temperature and pressure.

Materials and Methods:

Ab Initio Molecular Orbital Computational Details.

Molecular orbital (MO) studies on the π-complexation bonding for thiophene, benzene, aniline, pyrrole, indole, carbazole or methyl-carbazole on copper(I) zeolites were done using the Gaussian 98 package and Cerius2 molecular modeling software. Geometry optimizations were performed at the Hartree-Fock (HF) level.

Geometry Optimization and Bond Energy Calculations.

Frequency analysis was used to verify that all geometry optimized structures were true minima on the potential energy surface. The optimized structures were then used for bond energy calculations according to the following expression:
E_{ads}=E_{adsorbate}+E_{adsorbent}−E_{adsorbent-adsorbate} (1)
where E_{adsorbate} is energy of free adsorbate, E_{adsorbent} is energy of free adsorbent and E_{adsorbent-adsorbate} is energy of the adsorbate/adsorbent system. A higher value of E_{ads} corresponds to a stronger adsorption.
Models for Cu-Zeolite.

The copper zeolite model has a molecular formula of (HO)₃Si—O—Al(OH)₃, and the cation Cu⁺ sits 2.14 Å above the bridging oxygen between Si and Al. This cluster model is a good portrayal of the chemistry of a univalent cation bonded on site II (SII) of the faujasite framework.

Experimental Details:

Sorbent Preparation.

The starting sorbents used for denitrogenation studies were Na—Y zeolite (Si/Al=2.43, Strem Chemicals) and type PCB activated carbon (Calgon Corporation). These materials were used as received.

Cu(I)-Y (or auto-reduced Cu(II)-Y) was prepared by the following procedure: (1) ion exchange of Na—Y with a copper(II) nitrate aqueous solution (0.5 M) for 48 hours; (2) recovery of crystals followed by washing with about 4 L of deionized water; (3) drying at 90° C. overnight; (4) reduction of Cu²⁺ to Cu⁺. The cuprous zeolite was obtained after slowly heating up to 450° C. in helium. Slow heating may be accomplished by raising the temperature between about 1° C./minute and about 5° C./minute.

Reagents and Standards.

Diesel samples were obtained from a British-Petroleum (BP) station located in Ann Arbor, Mich., USA. The average total nitrogen concentration (from heterocycle compounds) for the diesel was reported to be 83 ppmw-N.

Fixed-Bed Adsorption/Breakthrough Experiments.

All dynamic adsorption/breakthrough experiments were performed in a vertical custom-made quartz reactor. This setup consisted of a low-flow liquid pump, Kynar compression fittings, Pyrex feed tanks, and a heating element. Initially, the sorbents were loaded inside the adsorber, and activated in situ as mentioned before. The gases used for activation were pretreated inline before contacting the sorbent using zeolite traps. After the activation treatment, the adsorbent was allowed to cool down to room temperature in helium.

Afterwards, a sulfur-free hydrocarbon was allowed to flow through the sorbent at a constant flow rate. This was necessary to remove entrapped gas remaining after the activation step. After wetting the adsorbent for several minutes, the feed was switched to commercial grade diesel fuel. The adsorber bed contained 1-2 g zeolite, while the feed flow rate was maintained at 0.5 cm³/min. Effluent samples were collected at regular intervals until saturation was reached, which depended on the adsorption dynamics and the amount of adsorbent. The samples were subsequently analyzed for nitrogen-containing compounds with a gas chromatograph (GC) equipped with a chemiluminescent nitrogen detector (CLND, by Antek Instruments, Inc.). The CLND was operated at a sensitivity (or detection limit) of approximately 0.015 ppbw N.

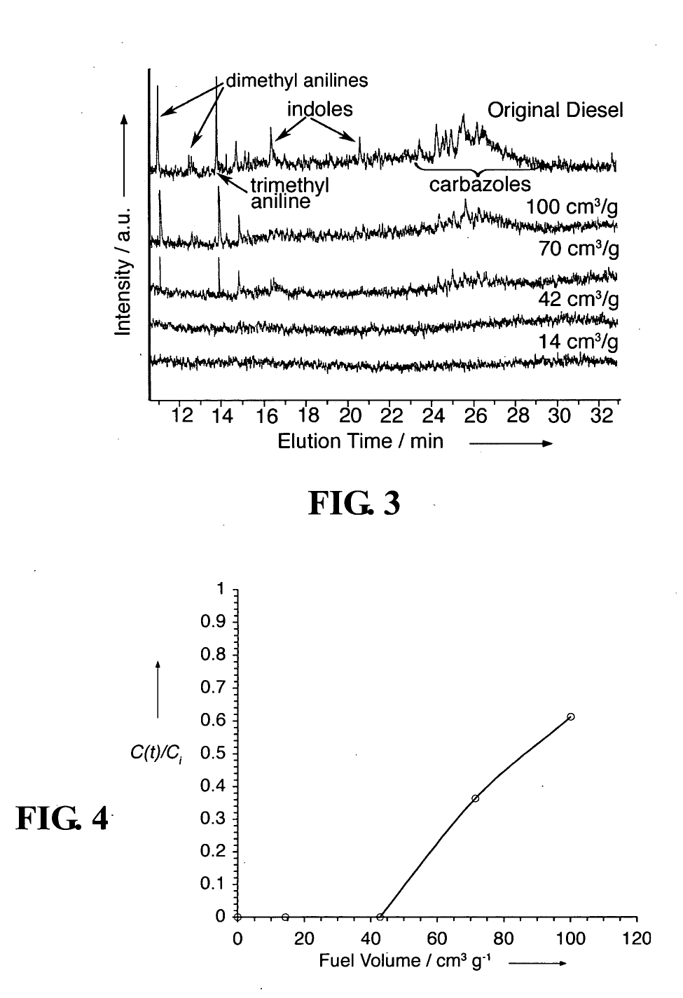

The results with the commercial diesel (containing 83 ppmw nitrogen) are summarized in FIG. 3 for CuY as the sorbent in the main bed. A thin layer of activated carbon (15% of the bed) was used as the guard bed that extended the sorbent capacity of the main bed by adsorbing the largest molecules from the fuels.

For desulfurization, the sulfur capacity was increased by about 20% by the guard bed. However, the concentration of nitrogen in the effluent (before nitrogen breakthrough) remained substantially the same without the guard bed. The nitrogen contents in the effluent product before the breakthrough point were below 0.1 ppmw nitrogen. The detailed nitrogen breakthrough behavior is shown in FIG. 4. The nitrogen analysis showed that the earliest nitrogen breakthrough appeared at a cumulative effluent volume of 43 cm³ g⁻¹. This corresponds to a very high and practical sorbent capacity of 3 mg nitrogen per g sorbent. It is to be understood that the zeolite sorbent selectively and effectively removed substantially all alkylcarbazoles (see FIG. 3). Further, it is well known that substituted carbazoles are poison for the hydrodesulfurization (HDS) of the refractory sulfur species in diesel.

Sorbent Regeneration.

The experiments performed on sorbent regeneration showed that CuY may be effectively regenerated either thermally or with solvents. CuY was regenerated by first treating with air at 350° C. (to burn off any sulfur which may be adsorbed by the CuY) followed by auto-reduction (of Cu²⁺ to Cu⁺). Further, it is to be understood that the temperature selected for regeneration should be sufficient to substantially remove the organo-nitrogen compounds from the sorbent. Afterwards, the original adsorption capacity was substantially completely recovered. For thermal regeneration, activated carbon may not be suitable for the guard bed; however, activated alumina would be effective.

While preferred embodiments of the invention have been described in detail, it will be apparent to those skilled in the art that the disclosed embodiments may be modified. Therefore, the foregoing description is to be considered exemplary rather than limiting, and the true scope of the invention is that defined in the following claims.

1. A method for removing organo-nitrogen compounds from liquid fuel, the method comprising the step of:
contacting the liquid fuel with an adsorbent which preferentially adsorbs the organo-nitrogen compounds, at a selected temperature and pressure, thereby producing a non-adsorbed component and an organo-nitrogen compound-rich adsorbed component, wherein the adsorbent includes at least one of a metal and a metal cation, the at least one of metal and metal cation adapted to form π-complexation bonds with the organo-nitrogen compounds, and wherein the preferential adsorption occurs by π-complexation.

2. The method as defined in claim 1 wherein the adsorbent comprises an ion-exchanged zeolite selected from the group consisting of zeolite X, zeolite Y, zeolite LSX, MCM-41 zeolites, silicoaluminophosphates, and mixtures thereof, the zeolite having exchangeable cationic sites, wherein at least some of the sites has the at least one of metal and metal cation present.

3. The method as defined in claim 2 wherein the adsorbent is a Cu(I)Y zeolite.

4. The method as defined in claim 2 wherein the at least one of metal and metal cation comprises at least one of Mn²⁺, Fe²⁺, Co²⁺, Ni²⁺, Cu³⁰ , Zn²⁺, Ga³⁺, Pd⁰, Ag⁺, and Cd²⁺.

5. The method as defined in claim 1 wherein the method further comprises the step of changing at least one of the pressure and temperature to thereby release the organo-nitrogen compound-rich component from the adsorbent.

6. The method as defined in claim 1 wherein prior to contacting the liquid fuel with the adsorbent, the method further comprises pretreating the adsorbent, the pretreatment process comprising the steps of:
activating the adsorbent at a temperature between about 250° C. and about 600° C. in at least one of a dry air atmosphere, air, an inert atmosphere and a reducing atmosphere for an amount of time ranging between about zero hours and about 20 hours; and then
cooling the adsorbent in at least one of a dry air atmosphere, air, and inert atmosphere.

7. The method as defined in claim 6 wherein the at least one of the metal and metal cation is Cu⁺ and wherein activating the adsorbent takes place in helium and cooling the adsorbent takes place in helium.

8. The method as defined in claim 1, further comprising the step of regenerating the adsorbent by treating the adsorbent at a temperature sufficient to substantially remove the organo-nitrogen compounds.

9. The method as defined in claim 8 wherein the treating temperature ranges between about 300° C. and about 600° C.

10. The method as defined in claim 8 wherein the at least one of metal and metal cation is Cu³⁰ , wherein treating takes place in air, and wherein regeneration further comprises the step of auto-reducing copper oxidized during the treating to Cu(I).

11. The method as defined in claim 1 wherein the liquid fuel is at least one of gasoline, diesel fuels, jet fuel, and mixtures thereof

12. The method as defined in claim 1 wherein the selected temperature and pressure is ambient temperature and ambient pressure.

13. The method as defined in claim 3 wherein the adsorbent adsorbs about 3 mg of nitrogen per gram of sorbent.

14. The method as defined in claim 1, further comprising the step of adding a guard bed adjacent an inlet to the adsorbent such that the liquid fuel contacts the guard bed prior to contacting the adsorbent.

15. The method as defined in claim 14 wherein the guard bed has as a main component thereof at least one of activated carbon, activated alumina, silica gel, zeolites, clays, pillared clays, diatomaceous earth, porous sorbents, and mixtures thereof.

16. The method as defined in claim 1 wherein the organo-nitrogen compounds include at least one of anilines, pyrroles, indoles, carbazoles, methyl-carbazoles, and mixtures thereof.

17. The method as defined in claim 1 wherein the adsorbent comprises a carrier having a surface area, wherein the at least one of metal and metal cation is in the form of a monolayer metal compound dispersed on the carrier surface area, the metal compound releasably retaining the organo-nitrogen compounds; and wherein the carrier comprises a plurality of pores having a pore size greater than the effective molecular diameter of the organo-nitrogen compounds.

18. The method as defined in claim 17 wherein the at least one of metal and metal cation comprises at least one of Mn²⁺, Fe²⁺, Co²⁺, Ni²⁺, Cu⁺, Zn²⁺, Ga³⁺, Pd⁰, Ag⁺, and Cd²⁺.

19. A method for removing organo-nitrogen compounds from liquid fuel comprising at least one of gasoline, diesel fuels, jet fuel, and mixtures thereof, the method comprising the steps of:
contacting the liquid fuel with an adsorbent which preferentially adsorbs the organo-nitrogen compounds, at ambient temperature and ambient pressure, thereby producing a non-adsorbed component and an organo-nitrogen compound-rich adsorbed component, wherein the adsorbent includes at least one of a metal aid a metal cation, the at least one of metal and metal cation adapted to form π-complexation bonds with the organo-nitrogen compounds, and wherein the preferential adsorption occurs by π-complexation;
wherein the adsorbent comprises an ion-exchanged zeolite selected from the group consisting of zeolite X, zeolite Y, zeolite LSX, MCM-41 zeolites, silicoaluminophosphates, and mixtures thereof, the zeolite having exchangeable cationic sites, wherein at least some of the sites has the at least one of metal and metal cation present; and
pretreating the adsorbent, the pretreatment process comprising the steps of:
activating the adsorbent by slowly heating the adsorbent up to a temperature of about 450° C. in a helium atmosphere for an amount of time ranging between about zero hours and about 20 hours, wherein slowly heating ranges between about 1° C./minute and about 5° C./minute; and then
cooling the adsorbent to room temperature in a helium atmosphere.

20. The method as defined in claim 19 wherein the adsorbent is a Cu(I)Y zeolite.

21. The method as defined in claim 19 wherein the at least one of metal and metal cation comprises at least one of Mn²⁺, Fe²⁺, Co²⁺, Ni²⁺, Cu⁺, Zn²⁺, Ga³⁺, Pd⁰, Ag⁺, and Cd²⁺.

22. The method as defined in claim 19 wherein the method further comprises the step of changing at least one of the pressure and temperature to thereby release the organo-nitrogen compound-rich component from the adsorbent.

23. The method as defined in claim 19 wherein the organo-nitrogen compounds include at least one of anilines, pyrroles, indoles, carbazoles, methyl-carbazoles, and mixtures thereof.

24. The method as difined in claim 20 wherein the adsorbent adsorbs about 3 mg of nitrogen per gram of sorbent.

25. The method as defined in claim 19, further comprising the step of regenerating the adsorbent by treating the adsorbent at a temperature sufficient to substantially remove the organo-nitrogen compounds, wherein the treating temperature ranges between about 300° C. and about 600° C.

26. The method as defined in claim 25 wherein the at least one of metal and metal cation is Cu⁺, wherein treating takes place in air, and wherein regeneration further comprises the step of auto-reducing copper oxidized during the treating to Cu(I).
